(19) United States
(12) Patent Application Publication
(10) Pub. No.: US 2007/0083456 A1
(43) Pub. Date: Apr. 12, 2007

(54) Algorithmic trading

(76) Inventor: Wayne Stuart Akers, Hertfordshire (GB)

Correspondence Address: FISH & RICHARDSON, PC, P.O. BOX 1022, MINNEAPOLIS, MN, 55440-1022, US

(21) Appl. No.: 11/202,384

(22) Filed: Aug. 10, 2005

Related U.S. Application Data
(60) Provisional application No. 60/603,942, filed on Aug. 23, 2004.

(30) Foreign Application Priority Data
Aug. 10, 2004 (GB) GB0417803.4

(51) Int. Cl. G06Q 40/00

(52) U.S. Cl. 705/37

(57) ABSTRACT

An algorithmic trading system in which the trading algorithms, the operation of which is variable based on values input by a user of various trading algorithm parameters, are encoded and stored within a file structure is described. A method of updating the trading algorithms and trading algorithm parameters is also described.

This application claims priority to U.S. Patent Application Ser. No. 60/603,942 filed on Aug. 23, 2004 and United Kingdom Patent Application Serial No. GB0417803.4 filed Aug. 10, 2004, the entire contents of which are hereby incorporated by reference.

This invention relates to automated execution algorithms, in particular those used by buy-side trading desks in financial trading situations.

Increasingly, brokers are offering automated execution algorithms (“Algorithmic Trading”) to their clients' buy-side trading desks. These algorithms may use large amounts of historical data to aid the prediction of trading patterns, and complex real-time data to assess current trading conditions. For example, stock price correlations between many thousands of stocks need to be re-calculated on a regular basis. The trading algorithms are intended to deliver price benefits and trading efficiencies, combined with different statistical analysis techniques and complex scheduling patterns, to avoid other market participants identifying trading patterns.

There are many possible approaches to algorithmic trading, for example using a “Benchmark” algorithm such as VWAP (Volume Weighted Average Price) (available from CSFB). Each counterparty with which a broker trades will offer and support a different set of algorithms. When requesting an algorithmic trade, buy-side traders have the option of controlling various parameters, such as participation rates, time and pacing controls, start and end times, aggression settings, price thresholds and limits and others.

Algorithmic trading instructions are often passed from the buy-side trader to the counterparty via FIX (Financial Information exchange) and the various algorithm parameters are defined in the FIX custom tags. FIX contains a delimited string of data that is a dedicated communication between brokers (or other sell-side personnel) and buy-side personnel, and is a messaging protocol for the exchange of financial information. FIX comprises a Session layer and an Application layer. The Session layer handles the actual connection between two counterparties, typically an Asset Manager (known as Buy Side) and Investment Bank (known as Sell Side). The Application layer deals with orders (for example BUY 100 IBM @ 105.4), executions (used to signal status or a fill, for example, partial fill 50 IBM @ 105.4), and allocation (once the trade is complete, an allocation to an account). The Application layer also encompasses amendments to orders, corrections to fills, cancellations, etc.

Versions 4.0 and 4.2 of FIX are a tag=value message format, for example, 10=5|35=A|22=2|55=IBM.L|102=105.4, with the message structure having a header, body and tail.

Known software applications dealing with algorithmic trading have the FIX destinations for each counterparty/algorithm/parameter combination that a user wishes to use hard coded into the software itself. However, these algorithms are not supported at the trader front end of the system. The main disadvantage of this is that if an additional algorithm is introduced by a counterparty, or required by a user, the entire software system must be updated as there is no means by which the additional algorithms and FIX destinations can be added to existing software. This is time consuming and costly, and results in there being a period of time where required algorithms cannot be used.

There is therefore a need to produce software which enables a trader to indicate for a release, or set of releases, that they wish to trade with a selected counterparty using a specific algorithm, and which can be updated when the algorithms issued by a particular counterparty are changed, or when a new counterparty that the trader wishes to trade with issues an algorithm or set of algorithms. The present invention aims to address that need.

The present invention provides an algorithmic trading system comprising

a file structure for storing encoded trading algorithms selectable by a user, each encoded trading algorithm having at least one encoded trading algorithm parameter associated therewith to vary the operation of the algorithm on input of algorithm parameter values, input means to allow a user to select an encoded trading algorithm from the file structure, to input trading information and to enter algorithm parameter values into the system, for the selected encoded trading algorithm, and communication means to allow the trading information and algorithm parameter values to be communicated to a third party in accordance with the selected encoded trading algorithm.

The invention also provides a method of updating the algorithmic data available to an algorithmic trading system, comprising the steps of encoding the algorithmic data, storing the encoded algorithmic data in a file structure, retrieving the algorithmic data from the file structure and uploading it into the algorithmic trading system.

The invention further provides an algorithmic trading method comprising the steps of encoding algorithmic data, selecting an encoded trading algorithm via a user input device, the operation of the encoded trading algorithm being variable based on algorithm parameter values input to at least one algorithm parameter associated with the encoded trading algorithm, storing the algorithmic data in a file structure, selecting an encoded trading algorithm via a user input device accessing the encoded trading algorithm from the user input device, inputting algorithm parameters values for the selected encoded trading algorithm and inputting trading information, and communicating the trading information and algorithm parameter values, in accordance with the algorithm parameters, to a third party.

The invention also provides a computer program product, for updating the algorithmic data available to an algorithmic trading system, wherein the algorithmic data comprises at least one trading algorithm associated with at least one trading algorithm parameter, the operation of the algorithm variable by algorithm parameter values input by a user, having program code stored thereon which when executed on a computer causes the computer to perform the steps of encoding the algorithmic data, storing the encoded algorithmic data in a file structure, retrieving the algorithmic data from the file structure and uploading it into the algorithmic trading system.

The invention yet further provides a computer program product for an algorithmic trading system, having program code stored thereon which when executed on a computer causes the computer to perform the steps of encoding algorithmic data, storing the algorithmic data in a file structure, selecting an encoded trading algorithm via a user input device, accessing the encoded trading algorithm and at least one associated encoded algorithm parameter, the operation of the algorithm variable by algorithm parameter values input by a user, from the user input device, inputting algorithm parameter values for the selected encoded trading algorithm and inputting trading information, and communicating the trading information and algorithm parameter values, in accordance with the algorithm parameters, to a third party.

The invention yet further provides a system for arranging algorithms to create an algorithmic trading system, the system comprising input means for receiving trading algorithms, the operation of each trading algorithm variable by one or more trading algorithm parameters, input means for receiving one or more trading algorithm parameters, and a file structure, arranged to store the trading algorithms and trading algorithm parameters in a manner accessible to a user to create an algorithmic trading system.

Preferably, the algorithmic data comprises at least one trading algorithm and/or at least one trading algorithm parameter.

Preferably, the algorithmic data is encoded in XML.

Preferably, the file structure is a database.

The invention gives the advantages that encoding the algorithmic data and storing it in a file structure enables the algorithmic data to be updated, for example, by the addition or removal of trading algorithms or trading algorithm parameters, without the need to alter the software or structure of the algorithmic trading system.

In addition, the encoding and storing of the algorithm data enables the user to name, store and retrieve, under a user-defined file name, frequently used algorithm parameters or algorithm parameter values.

Embodiments of the invention will now be described by way of example only, and with reference to the accompanying drawings in which:

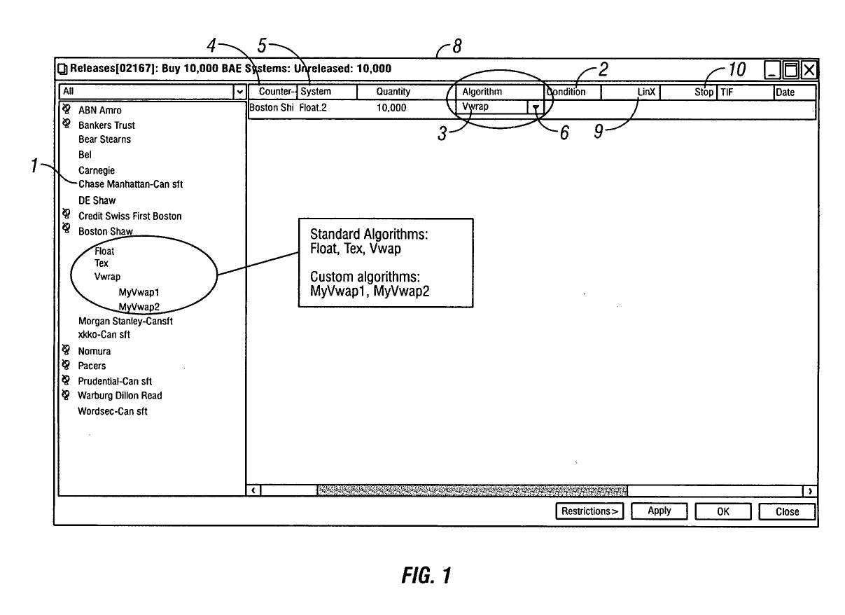

FIG. 1 is a screen shot of a release screen;

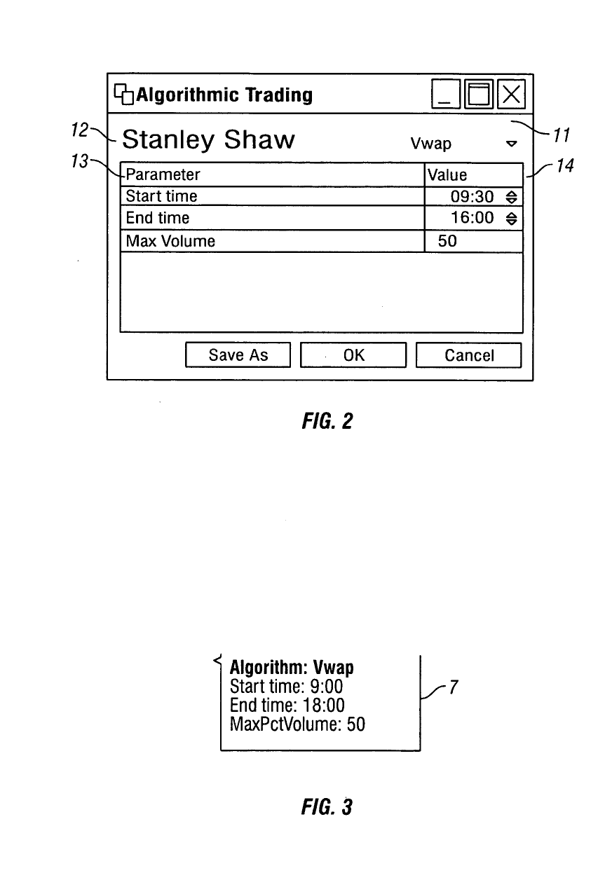

FIG. 2 is an example of an algorithm trading window;

FIG. 3 is an illustration of a tool tip used in connection with the screen of FIG. 1;

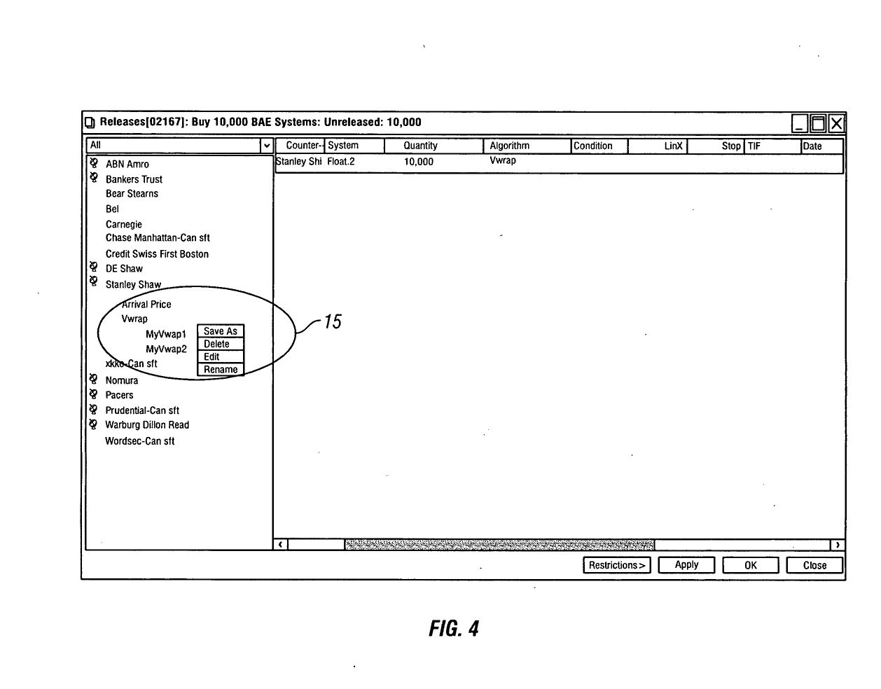

FIG. 4 shows a custom algorithm maintenance menu;

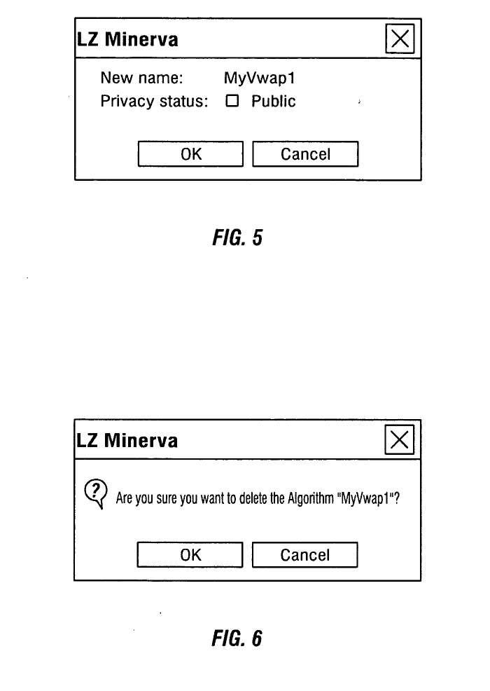

FIG. 5 illustrates saving an algorithm with a public/private visibility;

FIG. 6 shows a delete prompt;

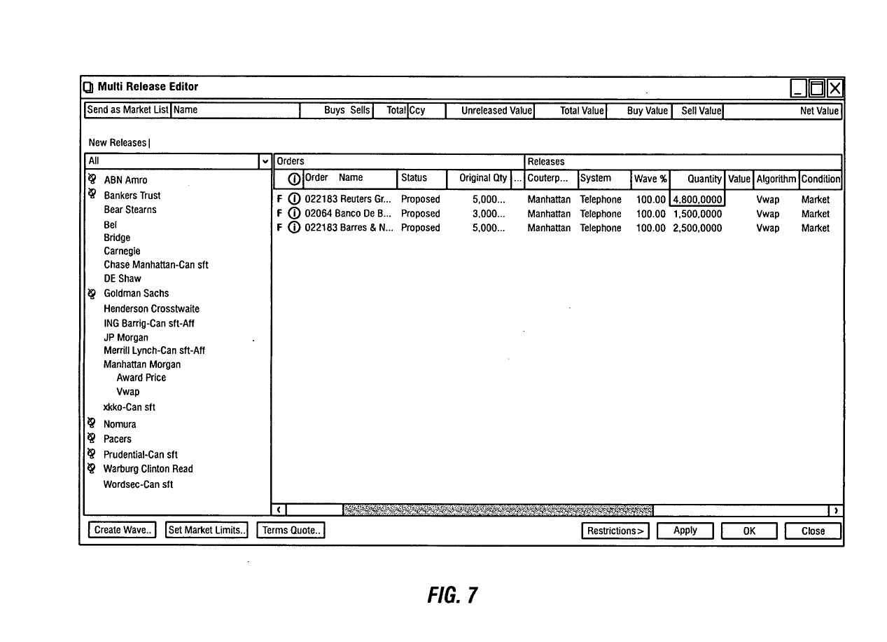

FIG. 7 is a screen show of a multi release edit window;

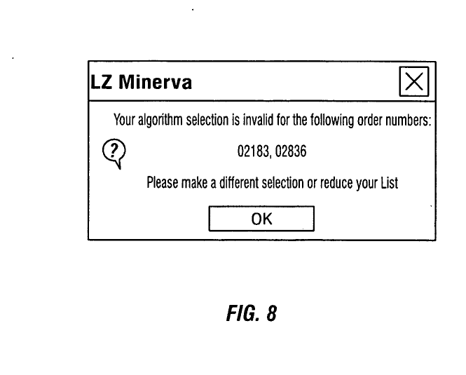

FIG. 8 shows a warning prompt for invalid algorithm selection;

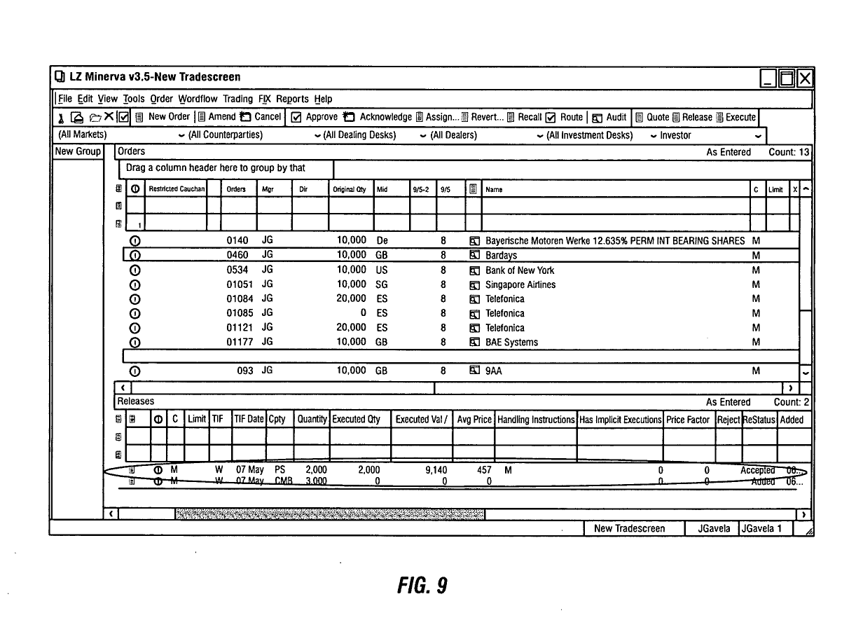

FIG. 9 is a screenshot of a trade screen;

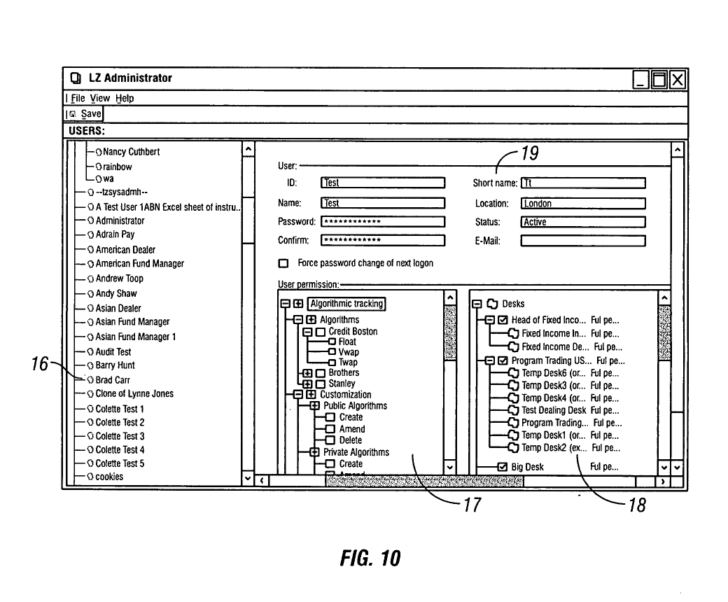

FIG. 10 is a screen shot of an algorithm permission tree; and

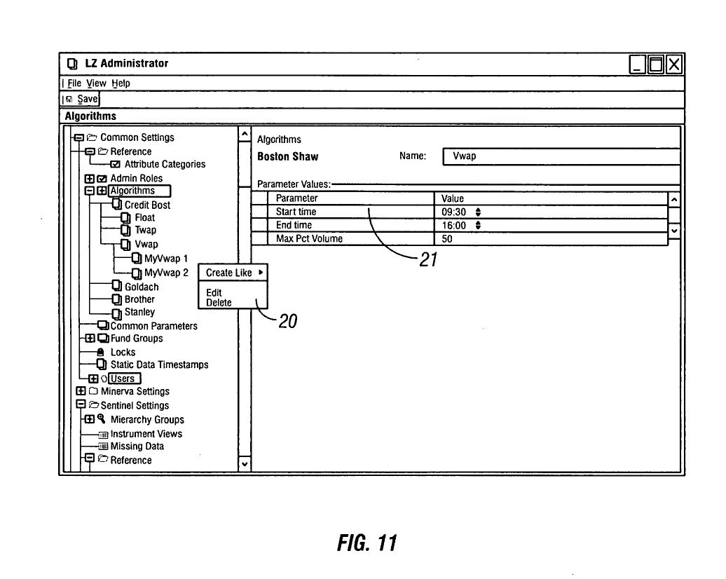

FIG. 11 is a screen show of a custom algorithm permissions tree.

As discussed above, brokers and banks are constantly introducing new trading algorithms with different parameters. In order to accommodate such changes, embodiments of the present invention provide a dynamic software system for algorithmic trading, in contrast to the static, hard-coded systems currently available. This is achieved by implementing the trading algorithms in a generic manner in three stages:
1. For each trading algorithm, the parameters available for that trading algorithm, the associated trading algorithm parameters and the format is defined in an XML (extensible Markup Language) schema, and stored in a database. The XML syntax describing the trading algorithms also includes the graphical user interface (GUI) control to be used for each parameter associated with the trading algorithm and their available values.
2. The screen display used by the trader to choose the trading algorithm and set the parameters is soft coded to read the XML schema and display the appropriate trading algorithms and parameters dependent upon the selected counterparty.
3. The FIX custom tags used to set the various parameters for each counterparty and trading algorithm are configured in the data transformation XML that is used by adapter software that allows the FIX data to be transmitted.

FIX data may be written using FIXML, an XML version of FIX. The tag=value structure of the original FIX format is retained, but the use of XML enables a more descriptive structure:

<flxmessage>

<header><flxversion>4.2<flxversion><header>

<body><qty>100<qty><side>B<side><symbol>IBM.I</symbol></body>

</flxmessage>

which represents trading of IBM data as on page 1.

The software system may be part of a buy-side trading system, such as that known as Minerva™, provided by LatentZero Limited, of London, England. The adapter software may be the LatentZero FIX Out Adapter, also provided by LatentZero Limited.

The advantage of coding the trading algorithms into an XML schema, stored in a database and accessed by the trading system, is that only the XML files in the database and the FIX custom tags need to be updated to support new trading algorithms. Although the invention is described in terms of accessing algorithmic data (trading algorithms and algorithm parameters) from a database, it is also possible to store the data in any suitable file structure format. Such a file structure format may be part of the system, remote from the system or networked to the system.

Various features of the invention necessary to support algorithmic trading will now be described.

Releasing Algorithmic Trades

When releasing orders to be executed as algorithmic trades, the trading algorithms available for trading are determined by the counterparty. Each counterparty supports a number of trading algorithms and requires a different set of parameters. When making a trading algorithm release, users must select the counterparty, trading algorithm and the parameters associated with the selected trading algorithm. Custom trading algorithms enable traders to store frequently used pre-defined parameter values under custom trading algorithm names. Each trading algorithm will have at least one algorithm parameter associated with it. In order to use the trading algorithm, a user will need to insert algorithm parameter values into the various prompts. Of these parameter values, some will be required (the trade cannot take place without the information) and some will be optional. If the optional values are not provided by the user, the system uses a pre-saved set of default values. Other trading information must also be provided by the user, such as quantities.

The release screen (the screen display seen by a user which details the sale being made and the options available) is shown in FIG. 1.

A counterparty list control 1 includes both standard trading algorithms and custom trading algorithms for each counterparty. Custom trading algorithms are algorithm parameter combinations saved by the user under a specific name for future reuse. Custom trading algorithms are described in more detail below. The counterparty list control 1 in FIG. 1 shows that the counterparty “Bank 1” offers three types of trading algorithms: “BA1”, “BB1” and “BC1”, and two custom trading algorithms: “MyBA1” and MyBA2”. The following items are shown in a tree structure under each counterparty:

standard trading algorithms supported by the counterparty, and nested under each trading algorithm:

custom trading algorithms defined as private by the current user;

custom trading algorithms defined as public.

Only trading algorithms defined as valid for the base type and market of the selected order are displayed. These restrictions are specified in the XML trading algorithm definition.

The counterparty control list 1 shows the trading algorithms in alphabetical order. The trading algorithms supported by each counterparty are saved in a table “trading_algorithm”. Custom trading algorithms available to each user are stored in a table “trading_algorithm_custom”. Both of these tables are described in more detail below.

FIG. 1 also shows a release strip 2. If the counterparty selected (via the counterparty list control or using a counterparty walker (not shown)) supports algorithmic trading, the trading algorithm is inserted into the strip in trading algorithm column 3.

If a trading algorithm node was selected in the counterparty list control 1, the trading algorithm is shown in the column 3. The counterparty column 4 will be populated with the counterparty name and the system column 5 will be pre-populated with the value corresponding to the FIX version used by the counterparty (for example, FIX4.2). Users are able to change this value from the list of valid systems for the selected counterparty.

If the counterparty node was selected (in the counterparty list control 1 or counterparty walker (not shown)) then the trading algorithm column 3 is blank. A drop-down combination box lists the trading algorithms for that counterparty as defined for the counterparty list control and in the same order. The combination box also includes a “blank” option to allow a non-trading algorithm release.

If a subsequent release is made to another counterparty that does not support algorithmic trading, the trading algorithm column 3 will still be displayed with the text<disabled>.

In subsequent releases, until a counterparty is selected, the trading algorithm column 3 will be set to blank, with no other option in its combination box.

When a standard trading algorithm is selected in the counterparty list control 1 by the user, default values (already stored or entered into the system) are assigned to the trading algorithm parameters. These default parameters are part of the XML trading algorithm description, stored in the database. If the user selects a custom trading algorithm from the counterparty list control 1, the trading algorithm name appears in the trading algorithm column 3 in the release strip 2, and the parameter values are set to those stored in connection with that particular custom trading algorithm.

The parameters of either standard or custom trading algorithms are editable in the same manner. A clickable button 6, shown as “a triangle” in trading algorithm column 3 in FIG. 1 invokes a trading algorithm parameters control. This is shown in more detail in FIG. 2.

When the user hovers the cursor over the trading algorithm field for a particular chosen trading algorithm release, a tool tip 7 is visible, as shown in FIG. 3. This tool tip 7 shows the parameter names and values associated with that trading algorithm, based on the data entered into the trading algorithm parameters control in FIG. 2. The tool tip is represented by a coloured triangle visible in the upper right corner of trading algorithm column 3.

The selected trading algorithm may support different order types, (for example, Limit orders), which are defined in XML for each trading algorithm, and stored in the database. If this is the case, the supported order types available are shown in the condition field 8 in the release strip 2. If the trading algorithm does not support different order types, then the condition field 8, limit 9 and stop 10 fields are blank and non-editable.

It is also possible for the user to select a trading algorithm where there are values already set at the condition and limit fields. If the trading algorithm supports the condition already set, then the condition and limit fields are left unchanged. If the trading algorithm supports different condition types, but does not support the condition currently set, the condition and limit fields are cleared down and are editable (such that a supported condition can be selected). If the trading algorithm selected does not support different order types, the condition and limit fields are cleared down and are non-editable.

Once an algorithmic release is created on the system, users are able to change the value of the trading algorithm from a combination box control. Valid trading algorithm control values in the combination box control follow the same rules as described in the counterparty list control 1. For example, if the entry in the “System” box is FIX, users can only modify the trading algorithm or its parameters if the selected counterparty supports Cancel/Replacement messages.

This functionality is indicated in the field “counterparty_params.order_replace_supported”. If the counterparty does not support these message types, the parameters are read-only fields.

Algorithmic Parameters Control.

FIG. 2 shows an example screen shot of the algorithmic parameter control window 11. The example shown is for a BA1 trading algorithm.

The title region 12 shows the counterparty name followed by the trading algorithm name. The trading algorithm name is in a drop down combination box that contains the names of all of the trading algorithms supported by the displayed counterparty. If the trading algorithm selected in the combination box is changed by the user, the input parameters and default values displayed in the window will change according to the trading algorithm selected by the user.

The window 11 displays two columns: a parameter name column 13 and a value column 14. The parameter column 13 displays the parameter names relevant for the trading algorithm selected, which are part of the XML definition. The value column 14 shows default values as defined for each trading algorithm. In the case of custom trading algorithms the values column 14 shows the saved parameter values. Users have “save”, “save as” and “cancel” options on the parameter input window 11:

selecting “save” causes the parameters input into the window to be accepted. Once the button is pressed, the input process is complete and the window 11 is closed.

Selecting “save as”: allows users to save the parameter values entered under a different trading algorithm name.

Selecting “cancel” closes the window once the button is pressed. The process resumes its previous state, as the user has interrupted this particular release.

Custom Trading Algorithms

FIG. 4 shows a custom trading algorithm maintenance menu 15. This menu may be invoked from the counterparty list control 1 using the right-click control on an existing trading algorithm on the list. A custom trading algorithm has associated with it the options save as, delete and edit, whereas only a save as option is available with standard trading algorithms. A custom trading algorithm comprises a set of algorithm parameters for a particular trading algorithm, saved under a user-defined name in the database, and retrievable from the database.

When users select the save as option, the “Algorithm Trading” window 11, which allows a user to update trading algorithm details within the window is displayed. The user is then prompted to enter the name of a trading algorithm. If the user has permission to create public trading algorithms (those available to any other user) then the “Public” box is clickable to mark the trading algorithm public as shown in FIG. 5. If this permission is denied or the “Public” box is not ticked, the window shows the text “Private”. The trading algorithm is saved in a table “trading_algorithm_custom”.

If a user types a trading algorithm name that already exists under his user ID or under the public domain, the system will inform the user that a trading algorithm with that same name already exists. The system simultaneously prompts the user to enter a different name or cancel an action. A duplicate name situation will arise in either of the following case:

If public status=“private” and an entry with the same trading algorithm name already exists in the table “trading_algorithm_custom” for the selected counterparty and current user, or the name already exists as “public” of the same counterparty; if the current user selects the privacy status=“public” then an entry with the same already exist in the table “trading_algorithm_custom” will select a counterparty under any user ID.

When users select the option “delete”, the custom trading algorithm from which the maintenance menu was invoked will be deleted. This system will prompt the user for conformational cancellation of the delete action. An example of a window used for this prompt is shown in FIG. 6. If the user confirms the action, the entry corresponding to the user ID, counterparty in trading algorithm will be deleted from the “trading_algorithm_custom” table.

When a user selects the option “edit”, the “algorithm trading” window will be presented with pre-populated parameter values as to find and accustomed trading algorithm selected. The options available are those of the “algorithm trading” window, as illustrated in FIG. 5, except the “save as” option. An “OK” option result from the saving of the trading algorithm details.

Multi-Release Editor

Traders can use the multi-release screen shown in FIG. 7 to release a group of orders as a list order. An example of such screen is shown in FIG. 7. The multi-release screen incorporates the trading algorithms in the counterparty list control 1 and also shows an “trading algorithm” column that contains details of the trading algorithms available. Both “copy/paste” and “copy to all” functionalities are available on this column, as well as on the other columns visible on the multi-release screen. If these two functions are used when copying from the counterparty column on a multi-release strip/grid containing trading algorithms, the trading algorithms, if any, in the destination rows are set to blank. However when copying from a trading algorithm on a multi-release strip/grid, data is only copied into rows in the grid where the counterparty is the same, and the trading algorithm restrictions are valid. If this is not the case, the destination trading algorithm is set to blank.

However when releasing orders as a Market List, normal orders and trading algorithms cannot be mixed, as there is only one FIX destination. The dropdown trading algorithm combination box in the multi-release strip/grid can only contain options that are valid on the entire set of orders displayed. If a user selects a trading algorithm from the counterparty list control 1 it is not valid for all the orders in the list, the user will receive a warning message and will be prompted to make a different selection or to reduce the list. This would be the situation where some of the orders do not pass all of the trading algorithm restrictions. An example of the window display to the user in this situation is shown in FIG. 8.

Release Reviewer

The release reviewer as shown in FIG. 9, is used to review details of the existing releases, and also contains a column relating to the trading algorithm available.

Algorithm Permissions

The user permission for each trading algorithm is managed from a central administration application. This may be an existing application such as the LZ Administration application, as available from LatentZero Limited. A trading algorithms node appears in the user permissions pane on the user maintenance screen. This node may be placed in alphabetical order in the users permissions tree structure. The node has two sub-nodes; “trading algorithms” and “customisation”.

The first sub-node trading algorithm in its expanded state will show the list of all available standard trading: algorithms nested under their corresponding counterparty names and the current permissions of the selected user. A trading algorithm is selected when its corresponding tick box is ticked. The second sub-node customisation, has two sections detailing the current user permissions accustom trading algorithms; public and private. Both public and private sections have permission options for the actions: create, amend and delete. FIG. 10 illustrates the trading algorithm trading permissions tree. The window is split into four panes: a user list 16 a trading algorithm list 17, a trading desk list 18 and a user information input panel 19. In order to use the administration application, and access the trading algorithm permissions, the user must provide ID and a password. The trading algorithm permission tree is used for managing both standard and customer trading algorithms.

A custom trading algorithm administration tree structure is shown in FIG. 11. This tree structure comprises the list of all available trading algorithms nested under their corresponding counterparty names (from the data table trading-algorithm table, discussed below) and associated custom trading algorithms (from the data table trading-algorithm-custom table as discussed below).

If a user right-clicks on a trading algorithm, a context menu 20 is displayed, containing 3 options, as appropriate for the selected user permission of the selected trading algorithm:

“create Like/Edit”: authorised users are able to create new custom trading algorithms from an existing standard or custom trading algorithm. The right had side of the screen displays the trading algorithm parameter control 21. Users can update parameter values (except for the trading algorithm name) and click the “save” button on the administration tree structure. “Delete”: if permissions allow, the selected trading algorithm may be deleted.

Restrictions

The order flow within the system is restricted. Each trading algorithm is only available on specified base types and markets, which are defined in the trading algorithm XML description. Traders can only save standard trading algorithms with other names in order to create custom trading algorithm for their own use. However standard trading algorithms cannot be deleted, changed or renamed. A standard trading algorithm is one defined by the offering counterparty. Traders can delete, change or rename the trading algorith ms defined by them, but not those defined by other traders. This is a case even if the trading algorithms are defined as public domain. The “copy/paste” and “copy to all” option at the multi-release screen is not available for the field trading algorithm. In market lists, a change of counterparty in a release element sets the trading algorithm value to blank, wherever the trading algorithm field is set to a different value. A change of counterparty/trading algorithm in one of the components from the counterparty list control 1 will result in the same pair being assigned to the remaining list components. Market lists also cannot mix trading algorithms and non trading algorithms.

The data table “trading-algorithm” table contains details linking counterparties with supported trading algorithms, as shown in Table 1 below:

TABLE 1

| Column | Data Type | Comment |
|---|---|---|
| counterparty_id | VarChar(16) | Foreign key |
| Algorithms | VarChar(4000) | XML description of trading |
| | | algorithms supported by |
| | | counterparty |

An example of this table populated for two counterparties is shown in Table 2:

TABLE 2

| Counterparty_id | Algorithms |
|---|---|
| Bank1 | <lzCounterparty name=“Bank1”> |

<parameters>

<parameter name=“Risk Factor” displayname=“Risk Factor” type=“char” format=“(LOW, MEDIUM, HIGH)”
default=“MEDIUM”

control=“combo box”/>

<parameter name=“Expire Time” displayname=“Expire Time” type=“time” format=“UTC” control=“date/time
control”/>

</parameters>
<restrictions>

<markets>

<market name=“*”/>

</markets>
<basetypes>

<!− Security −>
<basetype id=“1”/>
<!− Derivatives −>
<basetype id=“4”/>

</basetypes>
<conditions>

<condition name=“M”/>
<condition name=“L”/>

</conditions>

</restrictions>
<algorithm name=“BA1” value=“1”>

<parameters>

<parameter name=“Risk Factor” required=“Y”/>
<parameter name=“Expire Time” required=“Y”/>

</parameters>
<exclusions>

<markets>

<market name=“UK”/>

</markets>

</exclusions>

</algorithm>
<algorithm name=“ARRIVAL PRICE”

value=‘2”>

<parameters>

<parameter name=“Risk Factor” required=“Y”/>

</parameters>

</algorithm>

</lzCounterparty>

| | |
|---|---|
| Bank2 | <lzCounterparty name=“Bank2”> |

<parameters>

<parameter name=“Starttime” displayname=“Start time” type=“time” format=“UTC” default=“blank”
control=“date/time control”/>
<parameter name=“Endtime” displayname=“End time” type=“time” format=“UTC” default=“blank”
control=“date/time control”>

<dependency minervaattribute=“N” name=“Starttime” condition=“>=”/>

</parameter>
<parameter name=“MaxPctVolume” displayname=“Max Pct Volume” type=“int” format=“blank, 1”
default=“blank” control=“combo box” step=“10”/>
<parameter name=“ExecutionStyle” displayname=“Execution Style” type=“char” format=“1.1”
default=“10” control=“combo box” step=“1”/>
<parameter name=“DisplaySize” displayname=“Display Size” type=“int” default=“blank”
control=“combo box”>

<dependency minervaattribute=“Y” name=“OrderQty” condition=“&1t;=”/>

</parameter>
<parameter name=“MinPctVolume” displayname=“Min Pct Volume” type=“int” format=“blank,0..50”
default=“blank” control=“combo box”/>

</parameters>
<restrictions>

<markets>

<market name=“US”/>
<market name=“UK”/>

</markets>
<conditions>

<condition name=“M”/>
<condition name=“L”/>

</conditions>
<basetypes>

<!− Security −>
<basetype id=“1”/>

</basetypes>

</restrictions>
<algorithm name=“BD1” value=“2”>

<parameters>

<parameter name=“Starttime” required=“N”/>
<parameter name=“Endtime” required=“N”/>
<parameter name=“MaxPctVolume” required=“N”/>

</parameters>

</algorithm>

The data table “trading_algorithm custom” table contains details of the user that created the trading algorithm, the values assigned for each parameter and the privacy status assigned:

TABLE 3

| Column | Data Type | Comment |
|---|---|---|
| User_id | VarChar(10) | Composite key |
| Counterparty_id | VarChar(16) | Composite key |
| Algorithm_name | VarChar(20) | Composite key |
| Custom_name | VarChar(20) | Name assigned to the custom |
| | | trading algorithm |
| Privacy_status | VarChar(10) | “Public” or “Private” |
| Algorithm_values | VarChar(600) | XML definition of trading |
| | | algorithm parameters & values |

An example of this table populated for two users is shown in Table 4:

TABLE 4

| User_id | Cpty_id | Algorithm_name | Custom_name | Privacy_status | Algorithm_values |
|---|---|---|---|---|---|
| Tinvestor1 | Bank1 | BA1 | MyBA1 | Private | <parameters> |

parameter name=“Risk Factor” value=“MEDIUM”/>

<parameter name=“Expire Time” value=“2004052916300000”/>

| | | | | | |
|---|---|---|---|---|---|
| | | | | | </parameters> |
| Tinvestor1 | Bank1 | BB1 | MyBB1 | Public | <parameters> |

<parameter name=“Risk Factor” value=“HIGH”/>

| | | | | | |
|---|---|---|---|---|---|
| | | | | | </parameters> |
| Tinvestor2 | Bank2 | BD1 | MyBD1 | Private | <parameters> |

<parameter name=“Starttime” value=“2004052909300000”/>
<parameter name=“Endtime” value=“2004052916150000”/>
<parameter name=MaxPctVolume” value=“50”/>

</parameters>

XML Schema

The trading algorithm details provided by the sell-side counterparties are defined in the form of a XML schema. As brokers support new trading algorithms, these can be added easily to the schema.

As discussed above, the release table includes a trading algorithm column, which when stored in XML format has the characteristics shown in Table 5 below:

TABLE 5

| | Data Type | | |
|---|---|---|---|
| Column | & Size | Values | Comment |
| algorithm | VarChar(200) | Algorithm name | Example: <algorithm |
| | | and parameter | name=“Vwap” |
| | | values | Starttime=“090100” |
| | | | Endtime=“150000” |
| | | | MaxPctVolume=“50”/> |

The fix adapters pause and insert the trading algorithm parameters into the correct tags in the release table.

Users may wish to set various counterparty parameters differently depending on whether FIX releases are algorithmic or non-algorithmic. In order to enable this an additional Algorithmic column is added to the counterparty_parameters table.

TABLE 6

| | Data Type | | |
|---|---|---|---|
| Column | & Size | Values | Comment |
| algorithmic | Char | Y\| blank | Indicates that a parameter relates |
| | | | to trading algorithmic releases |

A counterparty parameter where Algorithmic=“Y” will override a parameter of the same name where Algorithmic=blank.

A new parameter_name, valid only for trading algorithms, is added to this table:
Parameter_name: “parameters_amended_supported”;
Possible values: “Y|N”;
Comment: set to “Y” indicates that the counterparty supports trading algorithm parameter amendments.

Algorithmic parameters are shown in Table 7 below:

TABLE 7

| Parameter name | Data Type | Values | Comment |
|---|---|---|---|
| “tif_values_supported” | VarChar(100) | List of valid TIF | TIFs supported on algorithmic |
| | | separated by commas | trades |
| “order_cancel_replace_supported” | Char | Y\|N | Cancel/replace messages supported |
| | | | for algorithmic trades |
| “parameters_amendment_supported” | Char | Y\|N | Whether counterparty supports amendments |
| | | | on their algorithm parameters. |
| “fix_version_id” | VarChar(5) | Fix protocol version | Fix protocol version for counterparty |
| | | | (i.e FIX.4.2) |
| “new_order_single_supported_file | Char | Y\|N | Indication of counterparty supporting |
| | | | releases by file |

The XML Schema

Below is a guide to the Trading algorithms XML schema as listed in Table 4.

Counterparty Level Definitions:

Parameter Default Values:

The “parameters” tag following a counterparty name describes all trading algorithm parameters for that counterparty. The “default” tag in the parameters section will define the default values. For instance, default=“MEDIUM”.

Parameter GUI Control:

The “control” tag in the parameters section will define the parameter GUI control such as combo box or time control.

Separators Used in Format Tag:

Multiple values will be separated by commas, for instance format=“Low, Medium, High”. An ellipsis will indicate a range of values, for instance format=“1.9”.

Dependencies:

Certain parameter values may be dependent on other parameters or Minerva order or release attributes, for instance, the parameter “EndTime” must be greater than parameter “StartTime”. Dependencies are expressed with 3 different tags grouped under the “dependency” tag:

“Minervaattribute”: Set to ‘Y’ indicates a dependency on a Minerva attribute when used in conjunction with the Minerva application available from LatentZero Limited. Set to “N” indicates a dependency on another parameter;

“Name”: name of the parameter or attribute on which the parameter value is dependent;

“Condition”: expresses the nature of dependency with standard relational operators. Multiple operators will be separated by “;” (e.g. “&lt;=” indicates “less than” or “equal to”).

Counterparty Support Restrictions

The “restrictions” tag describes combinations of order and release attributes restricting the algorithmic support by any given counterparty. For instance, the example in table 4 indicates that Bank2 supports trading algorithms only in US and UK markets (<restrictions><markets><market name=“US”/><market name=“UK”/></markets>).

There are three types of restrictions defined by the corresponding tag names:

Market: specifies instances of orders.market_id where the counterparty offers trading algorithms (e.g. “US”) (“*” will mean all markets);

Base types: specifies instances of orders.Minerva_instrument_type for which the counterparty offers trading algorithms (e.g. “1”)(“*” will mean all types);

Condition: specifies instances of releases.condition for which the counterparty offers trading algorithms (e.g. “M”).

Algorithm Level Definitions

Algorithm Exclusions

The “exclusions” tag describes combinations of order and release attributes for which algorithm level settings will override counterparty level settings. For instance, the example in table 4 indicates that Bank1 offers the algorithm “BA1” in all markets except the UK (<restrictions><markets><market name=“*”/></markets></restrictions>; . . . ;<exclusions><markets><market name=“UK”/></markets></exclusions>).

There are three types of restrictions defined by the corresponding tag names:

Market: specifies instances of order.market_id where the counterparty does not offer a specific trading algorithm (e.g. “UK”) (will mean all markets);

Base types: specifies instances of order.Minerva_instrument-type for which the counterparty does not offer a specific trading algorithm (e.g. “1”)(“*” will mean all types);

Condition: specifies instances of releases.condition for which the counterparty does not offer a specific trading algorithm (e.g. “L”).

Required Parameters:

When parameters are mandatory for a trading algorithm the “required” tag will be set to “Y”.

Various other modifications are possible and will occur to those skilled in the art without departing from the scope of the invention, which is defined by the following claims.

1. An algorithmic trading system comprising:
a file structure for storing encoded trading algorithms selectable by a user, each encoded trading algorithm having at least one encoded trading algorithm parameter associated therewith to vary the operation of the algorithm on input of algorithm parameter values;
input means to allow a user to select an encoded trading algorithm from the file structure, to input trading information and to enter algorithm parameter values into the system, for the selected encoded trading algorithm; and
communication means to allow the trading information and algorithm parameter values to be communicated to a third party in accordance with the selected encoded trading algorithm.

2. The algorithmic trading system of claim 1, wherein the file structure is a database.

3. The algorithmic trading system of claim 1, wherein the input means comprises at least one of a keyboard, mouse or tracker ball.

4. The algorithmic trading system of claim 1, wherein the input means further comprises a visual display for displaying the trading information and algorithm parameter values.

5. The algorithmic trading system of claim 1, wherein the communication means is a wireless network.

6. The algorithmic trading system of claim 1, wherein the communications means is a wired network.

7. The algorithmic trading system of claim 6, wherein the wired network comprises a telecommunications line.

8. The algorithmic trading system of claim 1, wherein trading information and algorithm parameter values are communicated to a third party using a FIX (financial information exchange) messaging protocol.

9. The algorithmic trading system of claim 1, wherein the file structure is remote from the trading system.

10. The algorithmic trading system of claim 1, wherein the encoded trading algorithm parameters associated with each encoded trading algorithm are stored in the file structure.

11. The algorithmic trading system of claim 1, wherein the trading algorithms and trading algorithm parameters are encoded in XML (extensible mark-up language).

12. The algorithmic trading system of claim 11, wherein the file structure is updatable.

13. The algorithmic trading system of claim 12, wherein the file structure is updated by the addition or removal of trading algorithms.

14. The algorithmic trading system of claim 12, wherein the file structure is updated by the addition or removal of trading algorithm parameters.

15. The algorithmic trading system of claim 1, wherein the algorithm parameter values are required values or optional values.

16. The algorithmic trading system of claim 15, wherein required values and optional values are stored in and retrieved from the file structure.

17. The algorithmic trading system of claim 16, wherein the required values are allocated a user-defined file name.

18. The algorithmic trading system of claim 16, wherein the optional values are allocated a user-defined file name.

19. The algorithmic trading system of claim 16, wherein the algorithm parameters are publicly available.

20. The algorithmic trading system of claim 16, wherein the algorithm parameters can only be accessed by a registered user.

21. The algorithmic trading system of claim 15, wherein when an optional value is not input by the user, a default value is provided.

22. The algorithmic trading system of claim 21, wherein the default values are stored in and retrieved from the file structure.

23. A method of updating the algorithmic data available to an algorithmic trading system, comprising the steps of:
encoding the algorithmic data;
storing the encoded algorithmic data in a file structure;
retrieving the algorithmic data from the file structure and uploading it into the algorithmic trading system.

24. The method of claim 23, wherein the algorithmic data comprises at least one trading algorithm.

25. The method of claim 23, wherein the algorithmic data comprises at least one trading algorithm parameter.

26. The method of claim 23, wherein the file structure is a database.

27. The method of claim 23, wherein the algorithmic data is encoded in XML (extensible mark-up language).

28. An algorithmic trading method comprising the steps of:
encoding algorithmic data;
storing the algorithmic data in a file structure;
selecting an encoded trading algorithm via a user input device, the operation of the encoded trading algorithm being variable based on algorithm parameter values input to at least one algorithm parameter associated with the encoded trading algorithm;
accessing the encoded trading algorithm from the user input device;
inputting algorithm parameter values for the selected encoded trading algorithm and inputting trading information; and
communicating the trading information and algorithm parameter values, in accordance with the algorithm parameters, to a third party.

29. The algorithmic trading method of claim 28, wherein the algorithmic data comprises at least one trading algorithm and at least one algorithm parameter.

30. The algorithmic trading method of claim 29, wherein the file structure is a database.

31. The algorithmic trading method of claim 29, wherein inputting data comprises typing on a keyboard, or selecting data using a mouse or a tracker ball.

32. The algorithmic trading method of claim 29, further comprising displaying the algorithm parameters values for the selected encoded trading algorithm and the trading information.

33. The algorithmic trading method of claim 29, wherein communicating to the third party takes place via a wireless network.

34. The algorithmic trading method of claim 29, wherein communicating to the third party takes place via a wired network.

35. The algorithmic trading method of claim 34, wherein the wired network comprises a telecommunications line.

36. The algorithmic trading method of claim 29, wherein communicating trading information and algorithm parameter values to the third party is via a FIX (financial information exchange) messaging protocol.

37. The algorithmic trading method of claim 29, further comprising accessing the algorithmic data remotely from the trading system.

38. The algorithmic trading method of claim 28, further comprising associating at least one encoded trading algorithm parameter with each encoded trading algorithm.

39. The algorithmic trading method of claim 28, wherein the step of encoding the algorithmic data comprises encoding the algorithmic data in XML (extensible mark-up language).

40. The algorithmic trading method of claim 39, further comprising updating the algorithmic data with additional algorithmic data.

41. The algorithmic trading method of claim 40, wherein the file structure is updated by the addition or removal of trading algorithms.

42. The algorithmic trading method of claim 40, wherein the file structure is updated by the addition or removal trading algorithm parameters.

43. The algorithmic trading method of claim 39, wherein the algorithm parameter values are required values or optional values.

44. The algorithmic trading method of claim 43, further comprising storing the required values and optional values in and retrieving the required and optional values from the file structure.

45. The algorithmic trading method of claim 44, further comprising allocating the required values a user defined file name.

46. The algorithmic trading method of claim 44, further comprising allocating the optional values a user defined file name.

47. The algorithmic trading, method of Claim 43, further comprising enabling the algorithm parameters to be publicly available.

48. The algorithmic trading method of claim 43, further comprising enabling the algorithm parameters to be available only to a registered user.

49. The algorithmic trading method of claim 43, further comprising providing a default parameter value when no optional value is input by the user.

50. The algorithmic trading method of claim 49, further comprising storing and retrieving the default values from the file structure.

51. A computer program product, for updating the algorithmic data available to an algorithmic trading system, wherein the algorithmic data comprises at least one trading algorithm associated with at least one trading algorithm parameter, the operation of the algorithm variable by algorithm parameter values input by a user, having program code stored thereon which when executed on a computer causes the computer to perform the steps of:
encoding the algorithmic data;
storing the encoded algorithmic data in a file structure;
retrieving the algorithmic data from the file structure and uploading it into the algorithmic trading system.

52. A computer program product for an algorithmic trading system, having program code stored thereon which when executed on a computer causes the computer to perform the steps of:
encoding algorithmic data;
storing the algorithmic data in a file structure;
selecting an encoded trading algorithm via a user input device;
accessing the encoded trading algorithm and at least one associated encoded algorithm parameter, the operation of the algorithm variable by algorithm parameter values input by a user, from the user input device;
inputting algorithm parameter values for the selected encoded trading algorithm and inputting trading information; and
communicating the trading information and algorithm parameter values, in accordance with the algorithm parameters, to a third party.

53. The computer program product of claim 52, wherein the algorithmic data comprises at least one trading algorithm and at least one algorithm parameter.

54. A system for arranging algorithms to create an algorithmic trading system, the system comprising:
input means for receiving trading algorithms, the operation of each trading algorithm variable by one or more trading algorithm parameters;
input means for receiving one or more trading algorithm parameters; and
a file structure, arranged to store the trading algorithms and trading algorithm parameters in a manner accessible to a user to create an algorithmic trading system.
